(19) United States
(12) Patent Application Publication
(10) Pub. No.: US 2024/0195573 A1
(43) Pub. Date: Jun. 13, 2024

(54) MAC CE FOR SEPARATE INDICATION OF DL TCI AND UL TCI

(71) Applicant: Lenovo (Beijing) Limited, Beijing (CN)

(72) Inventors: Bingchao Liu, Beijing (CN); Chenxi Zhu, Beijing (CN); Wei Ling, Beijing (CN); Yi Zhang, Beijing (CN); Lingling Xiao, Beijing (CN)

(73) Assignee: Lenovo (Beijing) Limited, Beijing (CN)

(21) Appl. No.: 18/286,200

(22) PCT Filed: Apr. 9, 2021
(86) PCT No.: PCT/CN2021/086084

§ 371 Date: Oct. 9, 2023

(51) Int. Cl. H04L 5/00; H04W 72/231

(52) U.S. Cl. CPC H04L 5/0053; H04W 72/231

(57) ABSTRACT

Methods and apparatuses for separate indication of DL TCI state and UL TCI state are disclosed. A method comprises receiving an MAC CE updating the mapping of multiple TCI codepoints and associated TCI state(s), wherein, each TCI codepoint is associated with one UL TCI state or one DL TCI state or both one DL TCI state and one UL TCI state.

### FIELD

The subject matter disclosed herein generally relates to wireless communications, and more particularly relates to methods and apparatuses for TCI-state Activation/Deactivation MAC CE for separate indication of DL TCI and UL TCI.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Transmission Configuration Indication (TCI), Media Access Control (MAC), MAC control element (MAC CE), Radio Resource Control (RRC), Downlink control information (DCI), Physical Downlink Shared Channel (PDSCH), Physical Uplink Shared Channel (PUSCH), Sounding Reference Signal (SRS), SRS resource indicator (SRI), identity (ID), Bandwidth Part (BWP), Physical Downlink Control Channel (PDCCH), quasi co-location (QCL), Demodulation Reference Signal (DM-RS), Channel State Information Reference Signal (CSI-RS).

The UE can be configured with a list of up to M TCI-State configurations to decode PDSCH according to a detected PDCCH with DCI intended for the UE and the given serving cell, where M depends on the UE capability. The TCI-state is configured by the following RRC signaling:

### TCI-State

The IE TCI-State associates one or two DL reference signals with a corresponding quasi co-location (QCL) type.

| | |
|---|---|
| | TCI-State information element |
| TCI-State ::= | SEQUENCE { |
| tci-StateId | TCI-StateId, |
| qcl-Type1 | QCL-Info, |
| qcl-Type2 | QCL-Info, |

}

| | |
|---|---|
| QCL-Info ::= | SEQUENCE { |
| cell | ServCellIndex, |
| bwp-Id | BWP-Id, |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

}

Each TCI-State contains parameters for configuring a quasi co-location (QCL) relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives an activation command used to map up to 8 TCI states to the codepoints of the DCI field ‘Transmission Configuration Indication’ in one DL BWP of a serving cell.

In NR Releases 15 and 16, up to 128 TCI states (i.e. DL TCI states) can be configured by RRC signaling for a UE in a serving cell according to UE capability. Some of the configured TCI states can be activated by an MAC CE. Each of the activated TCI state in the MAC CE is mapped to a codepoint (i.e. a value) of a TCI field contained in DCI format 1_1 or 1_2. When the UE receives a DCI format 1_1 scheduling a PDSCH transmission, the spatial RX parameter (maybe also referred to as DL RX beam or DL beam or RX beam) for receiving the scheduled PDSCH transmission is indicated by the TCI field in the DCI (i.e. by the activated TCI state mapped to the codepoint of the TCI field in the DCI).

The UL spatial relation (maybe also referred to as TX beam or UL beam or UL TX beam) for the scheduled PUSCH is implicitly determined by the spatialRelationInfo configured for the SRS resource indicated by SRI field contained in DCI format 0_1 or 0_2 in NR Releases 15 and Release 16.

Separate indication of DL beam and UL beam means that it is necessary to indicate DL beam and UL beam separately.

This disclosure targets supporting separate indication of DL TCI state and UL TCI state with flexibility.

### BRIEF SUMMARY

Methods and apparatuses for separate indication of DL TCI state and UL TCI state are disclosed.

In one embodiment, a method comprises receiving an MAC CE updating the mapping of multiple TCI codepoints and associated TCI state(s), wherein, each TCI codepoint is associated with one UL TCI state or one DL TCI state or both one DL TCI state and one UL TCI state.

In one embodiment, the MAC CE includes multiple TCI state ID fields each of which is associated with a one-bit indication field, the one-bit indication field indicates whether the associated TCI state ID field identifies an UL TCI state or a DL TCI state.

In another embodiment, one of the multiple TCI codepoints is associated with one DL TCI state or both one DL TCI state and one UL TCI state. Accordingly, the MAC CE includes multiple DL TCI state ID fields each of which is associated with one TCI codepoint and is associated with a one-bit indication field, the one-bit indication field indicates whether the one TCI codepoint is further associated with an UL TCI state identified by an UL TCI state ID field

In still another embodiment, the MAC CE includes multiple two-bits indication fields each of which is associated with one TCI codepoint, one bit of each two-bits indication field indicates whether the one TCI codepoint is associated with a DL TCI state identified by a DL TCI state ID field, and the other bit of the each two-bits indication field indicates whether the one TCI codepoint is associated with an UL TCI state identified by an UL TCI state ID field.

In one embodiment, a method comprises transmitting an MAC CE updating the mapping of multiple TCI codepoints and associated TCI state(s), wherein, each TCI codepoint is associated with one UL TCI state or one DL TCI state or both one DL TCI state and one UL TCI state.

In another embodiment, a remote unit (UE) comprises a receiver that receives an MAC CE updating the mapping of multiple TCI codepoints and associated TCI state(s), wherein, each TCI codepoint is associated with one UL TCI state or one DL TCI state or both one DL TCI state and one UL TCI state.

In yet another embodiment, a base unit comprises a transmitter that transmits an MAC CE updating the mapping of multiple TCI codepoints and associated TCI state(s), wherein, each TCI codepoint is associated with one UL TCI state or one DL TCI state or both one DL TCI state and one UL TCI state.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an MAC CE according to a first embodiment;

FIG. 2 illustrates an example of the MAC CE according to the first embodiment;

FIG. 3 illustrates an MAC CE according to a second embodiment;

FIG. 4 illustrates an example of the MAC CE according to the second embodiment;

FIG. 5 illustrates an MAC CE according to a third embodiment;

FIG. 6 illustrates an example of the MAC CE according to the third embodiment;

FIG. 7 is a schematic flow chart diagram illustrating an embodiment of a method;

FIG. 8 is a schematic flow chart diagram illustrating a further embodiment of a method; and

FIG. 9 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code.

This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

In the present disclosure, it is assumed that the UE supports separate DL TCI indication and UL TCI indication, or the UE is configured with separate DL TCI indication and UL TCI indication. It means that the UE can be indicated or updated with DL TCI state and UL TCI state separately. The expression “indicate a TCI state to UE” may mean that the TCI state is indicated to UE the first time, while the expression “update a TCI state to UE” may mean that the TCI state is indicated to UE the second time, the third time, etc (implying that the TCI state has been indicated to UE”. In the following description, the expression “update a TCI state to UE” intends to mean that the TCI state is indicated to the UE the first time, the second time, etc. This disclosure proposes to update UL TCI state and DL TCI state separately with one MAC CE. Separate DL TCI state pool and UL TCI state pool may be configured for the UE in a serving cell by RRC signaling. For example, a total of 128 TCI states (i.e. 128 DL TCI states) identified by TCI-StateID (e.g. TCI-state #0, TCI-state #1, . . . , and TCI-state #127) are configured by RRC signaling for DL TCI indication, and a total of 64 UL TCI states identified by UL-TCI-StateID (e.g. UL-TCI-state #0, UL-TCI-state #1, . . . , and UL-TCI-state #63) are configured by RRC signaling for UL TCI indication. Note that TCI-state #fn (n is one of 0 to 127) identifies a DL TCI state, while UL-TCI-state #n (n is one of 0 to 63) identifies an UL TCI state.

An MAC CE (e.g. TCI-state Activation/Deactivation MAC CE for Separate indication of DL TCI and UL TCI) is used to map some TCI state(s) (i.e. some DL TCI state(s)) and/or some UL TCI state(s)) to up to 8 TCI codepoints (e.g. codepoints 000, 001, 010, 011, 100, 101, 110, and 111) indicated by the TCI field contained in DCI format 1_1 or 1_2, where a codepoint (or TCI codepoint) is a value of the TCI field. A TCI codepoint can point to one or two TCI states (e.g. either a DL TCI state or an UL TCI state, or both the DL TCI state and the UL TCI state).

This disclosure proposes several MAC CEs (i.e. several MAC CE formats) for flexible mapping between TCI codepoints contained in DCI format 1_1 or 1_2 and DL TCI state and/or UL TCI state. The flexible mapping means that, for a UE with separate indication of DL TCI state and UL TCI state, only the DL TCI state or only the UL TCI state or both the DL TCI state and the UL TCI state can be updated for the TCI codepoints with an MAC CE. By using the MAC CE formats proposed in the present disclosure, DL TCI state for DL channel reception and/or UL TCI for UL channel transmission can be indicated by the TCI field contained in DCI format 1_1 or 1_2 without introducing additional field in the DCI format 1_1 or 1_2.

In consideration of different UE flexibilities of the mapping relation between TCI codepoints and the DL TCI state and/or the UL TCI state, different embodiments are provided.

According to a first embodiment, each TCI codepoint is mapped to only one TCI state that is either a DL TCI state or an UL TCI state. That is, each of some TCI codepoint(s) is only mapped to one DL TCI state while each of some other TCI codepoint(s) is only mapped to one UL TCI state.

The MAC CE according to the first embodiment is illustrated in FIG. 1. The following fields are included:

Serving Cell ID (with 5 bits): the Serving Cell ID field indicates the identity of the Serving Cell for which the MAC CE applies.

BWP ID (with 2 bits): the BWP ID field indicates a BWP for which the MAC CE applies.

TCI state ID n (n can have 8 candidate values (for example, n=0 to N, N is 7) to support 8 candidate TCI codepoints indicated by TCI field contained in DCI) (each with 7 bits): the TCI state ID n field indicates the DL TCI state identified by TCI-StateID or UL TCI state identified by UL-TCI-StateID for the n^{th} codepoint (i.e. any of codepoints 000, 001, 010, 011, 100, 101, 110, and 111) of Transmission Configuration Indication (TCI) field of the DCI. The Cₙ field indicates whether the TCI state ID n is a DL TCI state or an UL TCI state.

Cₙ (n=0 to N) (each with 1 bit): the Cₙ field indicates whether the TCI state ID n is a TCI state ID identifying a DL TCI state or an UL TCI state ID identifying an UL TCI state (or whether the TCI state ID n identifies a DL TCI state or an UL TCI state). For example, Cₙ field set to “1” indicates that the TCI state ID n field is an UL TCI state ID identifying an UL TCI state, while Cₙ field set to “0” indicates that the TCI state ID n field is a TCI state ID identifying a DL TCI state, or vice versa (i.e. Cₙ field set to “0” indicates that the TCI state ID n field is an UL TCI state ID identifying an UL TCI state, while Cₙ field set to “1” indicates that the TCI state ID n field is a TCI state ID identifying a DL TCI state).

R: R field is reserved and set to 0.

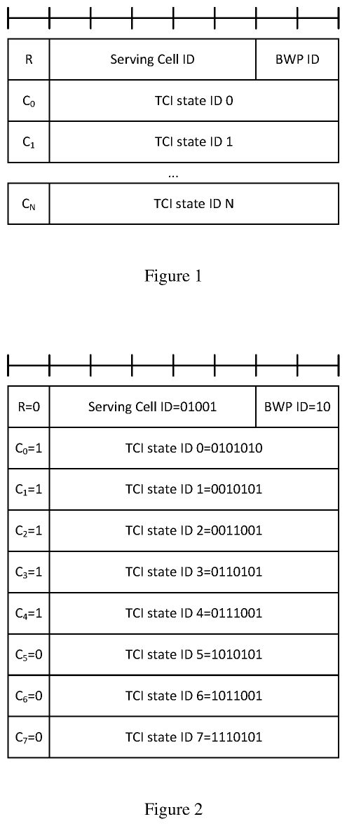

An example of the MAC CE according to the first embodiment is illustrated in FIG. 2.

If a UE receives the MAC CE illustrated in FIG. 2, the UE shall, for serving cell with identity of 01001 and BWP with identity of 10,
map TCI codepoint 000 to UL TCI state with UL-TCI-state #42 identified by TCI state ID 0 field (=0101010) since C₀ is set to 1;
map TCI codepoint 001 to UL TCI state with UL-TCI-state #21 identified by TCI state ID 1 field (=0010101) since C₁ is set to 1;
map TCI codepoint 010 to UL TCI state with UL-TCI-state #25 identified by TCI state ID 2 field (=0011001) since C₂ is set to 1;
map TCI codepoint 011 to UL TCI state with UL-TCI-state #53 identified by TCI state ID 3 field (=0110101) since C₃ is set to 1;
map TCI codepoint 100 to UL TCI state with UL-TCI-state #57 identified by TCI state ID 4 field (=0111001) since C₄ is set to 1;
map TCI codepoint 101 to DL TCI state with TCI-state #85 identified by TCI state ID 5 field (=1010101) since C₅ is set to 0;
map TCI codepoint 110 to DL TCI state with TCI-state #89 identified by TCI state ID 6 field (=1011001) since C₆ is set to 0; and
map TCI codepoint 111 to DL TCI state with TCI-state #117 identified by TCI state ID 7 field (=1110101) since C₇ is set to 0.

For example, if the UE receives a DCI format 1_1 containing a TCI field with codepoint 001, it will update the UL TCI to UL-TCI-state #21. For another example, if the UE receives a DCI format 1_1 containing a TCI field with codepoint 110, it will update the DL TCI to TCI-state #89.

The MAC CE according to the first embodiment includes 8 TCI state ID fields (TCI state ID n, n=0 to 7) each of which is associated with the nu TCI codepoint and is associated with a one-bit indication field (e.g. Cₙ). The one-bit indication field (e.g. Cₙ) indicates whether the associated TCI state ID (TCI state ID n) field identifies an UL TCI state or a DL TCI state (i.e. whether the associated TCI state ID field is an UL TCI state ID identifying an UL TCI state or is a DL TCI state ID identifying a DL TCI state). For example, if Cₙ is set to 1, the associated TCI state ID (TCI state ID n) field identifies an UL TCI state (i.e. the associated TCI state ID (TCI state ID n) field is an UL TCI state ID identifying an UL TCI state), while if Cₙ is set to 0, the associated TCI state ID (TCI state ID n) field identifies a DL TCI state (i.e. the associated TCI state ID field (TCI state ID n) is a DL TCI state ID identifying a DL TCI state).

A second embodiment is made in consideration that the DL TCI state may change more frequently than the UL TCI state. According to the second embodiment, each TCI codepoint is mapped to a DL TCI state and optionally an UL TCI state. It means that each of some TCI codepoint(s) is only mapped to a DL TCI state while each of some other TCI codepoint(s) is mapped to both a DL TCI state and an UL TCI state.

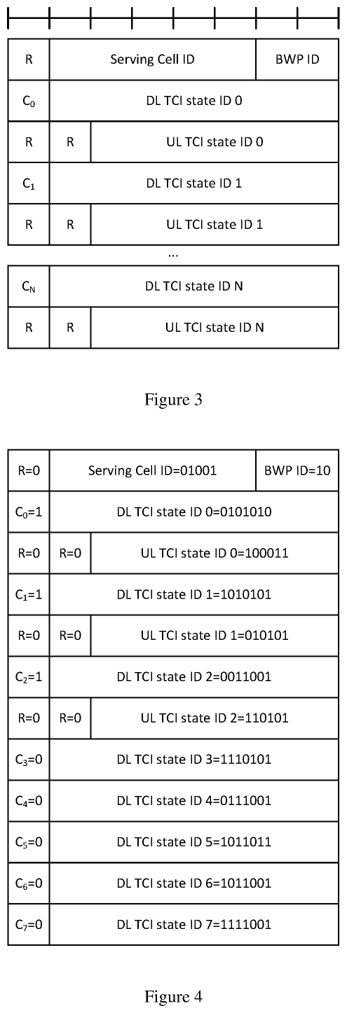

The MAC CE according to the second embodiment is illustrated in FIG. 3. The following fields are included:
Serving Cell ID (with 5 bits): the Serving Cell ID field indicates the identity of the Serving Cell for which the MAC CE applies.
BWP ID (with 2 bits): the BWP ID field indicates a BWP for which the MAC CE applies.
DL TCI state ID n (n=0 to N, N is for example 7) (each with 7 bits): the DL TCI state ID n field indicates the DL TCI state identified by TCI-StateID for the n^{th} codepoint of TCI field the DCI.
UL TCI state ID n (n=0 to N) (each with 6 bits): the UL TCI state ID n field indicates the UL TCI state identified by UL-TCI-StateID for the n^{th} codepoint of TCI field the DCI. The presence or absence of the UL TCI state ID n field (the octet containing the UL TCI state ID n field) depends on the Cₙ field.
Cₙ (n=0 to N) (each with 1 bit): the Cₙ field indicates whether both the DL TCI state ID n field (the octet containing the DL TCI state ID n field) and the UL TCI state ID n field (the octet containing the UL TCI state ID n field) are present or only the DL TCI state ID n field (the octet containing the DL TCI state ID n field) is present (i.e. UL TCI state ID n (the octet containing the UL TCI state ID n field) is absent). For example, Cₙ field set to “1” indicates that both the DL TCI state ID n field and the UL TCI state ID n field are present, while Cₙ field set to “0” indicates that only the DL TCI state ID n field is present while the UL TCI state ID n field is absent, or vice versa (Cₙ field set to “0” indicates that both the DL TCI state ID n field and the UL TCI state ID n field are present, while Cₙ field set to “1” indicates that only the DL TCI state ID n field is present while the UL TCI state ID n field is absent). In other words, when Cₙ field is set to “1”, the n^{th} codepoint of TCI field the DCI is mapped to two TCI states (i.e. one DL TCI state and one UL TCI state) indicated respectively by the DL TCI state ID n field and the UL TCI state ID n field; and when Cₙ field is set to “0”, the nu codepoint of TCI field the DCI is mapped to only one DL TCI state indicated by the DL TCI state ID n field.
R: R field is reserved and set to 0.

An example of the MAC CE according to the second embodiment is illustrated in FIG. 4.

If a UE receives the MAC CE illustrated in FIG. 4, the UE shall, for serving cell with identity of 01001 and BWP with identity of 10,
map TCI codepoint 000 to DL TCI state with TCI-state #42 identified by DL TCI state ID 0 field (=0101010) and UL TCI state with UL-TCI-state #35 identified by UL TCI state ID 0 field (=100011), since C₀ is set to 1;
map TCI codepoint 001 to DL TCI state with TCI-state #85 identified by DL TCI state ID 1 field (=1010101) and UL TCI state with UL-TCI-state #21 identified by UL TCI state ID 1 field (=010101), since C₁ is set to 1;
map TCI codepoint 010 to DL TCI state with TCI-state #25 identified by DL TCI state ID 2 field (=0011001) and UL TCI state with UL-TCI-state #53 identified by UL TCI state ID 2 field (=110101), since C₂ is set to 1;
map TCI codepoint 011 only to DL TCI state with TCI-state #117 identified by DL TCI state ID 3 field (=1110101), since C₃ is set to 0 (UL TCI state ID 3 field is absent);
map TCI codepoint 100 only to DL TCI state with TCI-state #57 identified by DL TCI state ID 4 field (=0111001), since C₄ is set to 0 (UL TCI state ID 4 field is absent);
map TCI codepoint 101 only to DL TCI state with TCI-state #91 identified by DL TCI state ID 5 field (=1011011), since C₅ is set to 0 (UL TCI state ID 5 field is absent);
map TCI codepoint 110 only to DL TCI state with TCI-state #89 identified by DL TCI state ID 6 field (=1011001), since C₆ is set to 0 (UL TCI state ID 6 field is absent); and
map TCI codepoint 111 only to DL TCI state with TCI-state #121 identified by DL TCI state ID 7 field (=1111001), since C₇ is set to 0 (UL TCI state ID 7 field is absent).

For example, if the UE receives a DCI format 1_1 containing a TCI field with codepoint 001, it will simultaneously update the DL TCI to TCI-state #85 and update the UL TCI to UL-TCI-state #21. For another example, if the UE receives a DCI format 1_1 containing a TCI field with codepoint 110, it will update the DL TCI to TCI-state #89.

The MAC CE according to the second embodiment includes 8 DL TCI state ID fields (DL TCI state ID n, n=0 to 7) each of which is associated with the n^{th} TCI codepoint and is associated with a one-bit indication field (e.g. Cₙ). The one-bit indication field (e.g. Cₙ) indicates whether the n^{th} TCI codepoint is further associated with an UL TCI state identified by an UL TCI state ID field (e.g. UL TCI state ID n). For example, if Cₙ is set to 1, the n^{th} TCI codepoint is further associated with an UL TCI state identified by UL TCI state ID n field (i.e. the n^{th} TCI codepoint is associated with both a DL TCI state identified by DL TCI state ID n field and an UL TCI state identified by UL TCI state ID n field). If Cₙ is set to 0, the n^{th} TCI codepoint is not further associated with an UL TCI state (i.e. the nu TCI codepoint is only associated with a DL TCI state identified by DL TCI state ID n field while the UL TCI state ID n field (the octet containing the UL TCI state ID n field) is absent).

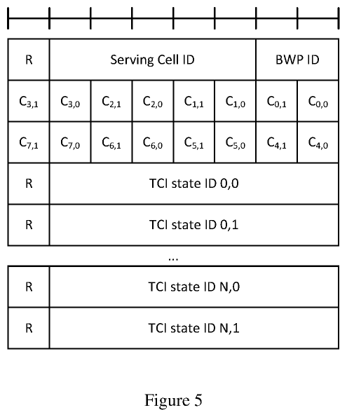

To provide full flexibility, the best option is that each TCI codepoint may point to a DL TCI state, or an UL TCI state or both the DL TCI state and the UL TCI state. The MAC CE according to the third embodiment, that is made to provide full flexibility, is illustrated in FIG. 5. The following fields are included:

Serving Cell ID (with 5 bits): the Serving Cell ID field indicates the identity of the Serving Cell for which the MAC CE applies.

BWP ID (with 2 bits): the BWP ID field indicates a BWP for which the MAC CE applies.

TCI state ID n,0 (n=0 to N, N is for example 7) (each with 7 bits): the TCI state ID n,0 field indicates the DL TCI state identified by TCI-StateID for the n^{th} codepoint of TCI field of the DCI. The presence or absence of the UL TCI state ID n,0 (the octet containing the UL TCI state ID n,0) depends on the C_{n,0} field.

TCI state ID n,1 (n=0 to N) (each with 7 bits): the TCI state ID n,1 field indicates the UL TCI state identified by UL-TCI-StateID for the n^{th} codepoint of TCI field of the DCI. The presence or absence of the UL TCI state ID n,1 (the octet containing the UL TCI state ID n,1) depends on the C_{n,1} field.

C_{n,0} (n=0 to N, N is for example 7) (each with 1 bit): the C_{n,0} field indicates whether the TCI state ID n,0 field (the octet containing the UL TCI state ID n,0) is present. For example, C_{n,0} field set to “1” indicates that the TCI state ID n,0 is present, and C_{n,0} field set to “0” indicates that the TCI state ID n,0 field is absent, or vice versa (C_{n,0} field set to “0” indicates that the TCI state ID n,0 is present, and C_{n,0} field set to “1” indicates that the TCI state ID n,0 field is absent).

C_{n,1} (n=0 to N, N is for example 7) (each with 1 bit): the C_{n,1} field indicates whether the UL TCI state n,1 (the octet containing the UL TCI state ID n,1) is present. For example, C_{n,1} field set to “1” indicates that the TCI state ID n,1 is present, and C_{n,1} field set to “0” indicates that the TCI state ID n,1 field is absent, or vice versa C_{n,1} field set to “0” indicates that the TCI state ID n,1 is present, and C_{n,1} field set to “1” indicates that the TCI state ID n,1 field is absent.

R: R field is reserved and set to 0.

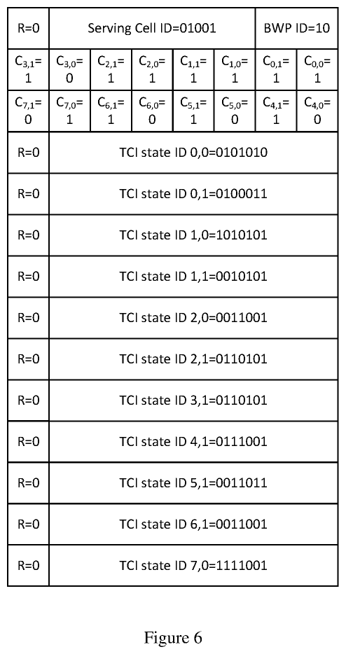

An example of the MAC CE according to the third embodiment is illustrated in FIG. 6.

If a UE receives the MAC CE illustrated in FIG. 6, the UE shall, for serving cell with identity of 01001 and BWP with identity of 10,
map TCI codepoint 000 to DL TCI state 42 indicated by TCI state ID 0,0 field (=0101010) (since C_{0,0} field is set to 1) and UL TCI state 35 indicated by TCI state ID 0,1 field (=0100011) (since C_{0,1} field is set to 1);
map TCI codepoint 001 to DL TCI state 85 indicated by TCI state ID 1,0 field (=1010101) (since C_{1,0} field is set to 1) and UL TCI state 21 indicated by TCI state ID 1,1 field (=0010101) (since C_{1,1} field is set to 1);
map TCI codepoint 010 to DL TCI state 25 indicated by TCI state ID 2,0 field (=0011001) (since C_{2,0} field is set to 1) and UL TCI state 53 indicated by TCI state ID 2,1 field (=0110101) (since C_{2,1} field is set to 1);
map TCI codepoint 011 only to UL TCI state 53 indicated by TCI state ID 3,1 field (=0110101) (since C_{3,1} field is set to 1), while C_{3,0} field is set to 0, indicating that TCI state ID 3,0 field (the octet containing TCI state ID 3,0 field) is absent;
map TCI codepoint 100 only to UL TCI state 57 indicated by TCI state ID 4,1 field (=0111001) (since C_{4,1} field is set to 1), while C_{4,0} field is set to 0, indicating that TCI state ID 4,0 field (the octet containing TCI state ID 4,0 field) is absent;
map TCI codepoint 101 only to UL TCI state 27 indicated by TCI state ID 5,1 field (=0011011) (since C_{5,1} field is set to 1), while C_{5,0} field is set to 0, indicating that TCI state ID 5,0 field (the octet containing TCI state ID 5,0 field) is absent;
map TCI codepoint 110 only to UL TCI state 25 indicated by TCI state ID 6,1 field (=0011001) (since C_{6,1} field is set to 1), while C_{6,0} field is set to 0, indicating that TCI state ID 6,0 field (the octet containing TCI state ID 6,0 field) is absent; and
map TCI codepoint 111 only to DL TCI state 121 indicated by TCI state ID 7,0 field (=1111001) (since C_{7,0} field is set to 1), while C_{7,1} field is set to 0, indicating that TCI state ID 7,1 field (the octet containing TCI state ID 7,1 field) is absent.

For example, if the UE receives a DCI format 1_1 containing a TCI field with codepoint 001, it will simultaneously update the DL TCI to TCI-state #85 and update the UL TCI to UL-TCI-state #21. For another example, if the UE receives a DCI format 1_1 containing a TCI field with codepoint 111, it will only update the DL TCI to TCI-state #121.

The MAC CE according to the third embodiment includes 8 two-bits indication fields (C_{n,0} and C_{n,1}, n=0 to 7) each of which is associated with the n^{th} TCI codepoint. One bit of each two-bits indication field (e.g. C_{n,0}) indicates whether the n^{th} TCI codepoint is associated with a DL TCI state identified by a DL TCI state ID (i.e. TCI state ID n,0) field. The other bit of the two-bits indication fields (e.g. C_{n,1}) indicates whether the n^{th} TCI codepoint is associated with an UL TCI state identified by an UL TCI state ID (i.e. TCI state ID n,1) field. For example, if C_{n,0} is set to 1 and C_{n,1} is set to 1, the n^{th} TCI codepoint is associated with both a DL TCI state identified by TCI state ID n,0 field and an UL TCI state identified by TCI state ID n,1 field; if C_{n,0} is set to 1 and C_{n,1} is set to 0, the nu TCI codepoint is associated with a DL TCI state identified by TCI state ID n,0 field while the TCI state ID n,1 field (the octet containing TCI state ID n,1 field) is absent; and if C_{n,0} is set to 0 and C_{n,1} is set to 1, the n^{th} TCI codepoint is associated with an UL TCI state identified by TCI state ID n,1 field while the TCI state ID n,0 field (the octet containing TCI state ID n,0 field) is absent.

As a whole, any of the MAC CEs according to the first, the second and the third embodiments can indicate or update the DL TCI state and/or the UL TCI state mapped to each of TCI codepoints of a DCI (e.g. DCI format 1_1 or 1_2 in NR Release 15 or 16). In addition, the base station can configure only a set of DL TCI states and another set of UL TCI states by using the same way as in NR Release 15 or 16. The mapping between each TCI codepoint and DL TCI state and/or the UL TCI state can be indicated or updated by any of the MAC CEs according to the first, the second and the third embodiments.

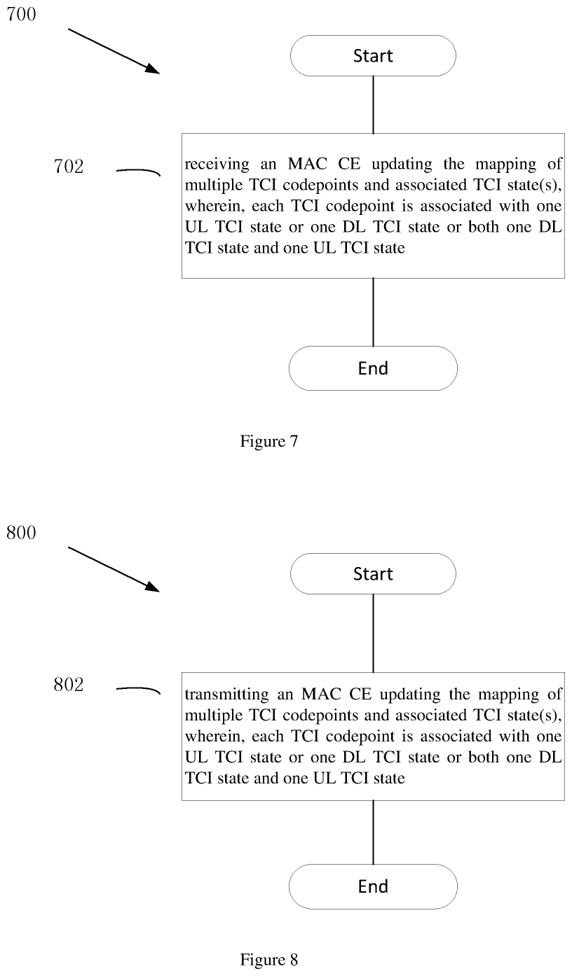

FIG. 7 is a schematic flow chart diagram illustrating an embodiment of a method 700 according to the present application. In some embodiments, the method 700 is performed by an apparatus, such as a base unit. In certain embodiments, the method 700 may be performed by a processor executing program code, for example, a microcontroller, a microprocessor, a CPU, a GPU, an auxiliary processing unit, a FPGA, or the like.

The method 700 may include 702 receiving an MAC CE updating the mapping of multiple TCI codepoints and associated TCI state(s), wherein, each TCI codepoint is associated with one UL TCI state or one DL TCI state or both one DL TCI state and one UL TCI state.

In one embodiment, the MAC CE includes multiple TCI state ID fields each of which is associated with a one-bit indication field, the one-bit indication field indicates whether the associated TCI state ID field identifies an UL TCI state or a DL TCI state. In another embodiment, one of the multiple TCI codepoints is associated with one DL TCI state or both one DL TCI state and one UL TCI state, and accordingly, the MAC CE includes multiple DL TCI state ID fields each of which is associated with one TCI codepoint and is associated with a one-bit indication field, the one-bit indication field indicates whether the one TCI codepoint is further associated with an UL TCI state identified by an UL TCI state ID field. In still another embodiment, the MAC CE includes multiple two-bits indication fields each of which is associated with one TCI codepoint, one bit of each two-bits indication field indicates whether the one TCI codepoint is associated with a DL TCI state identified by a DL TCI state ID field, and the other bit of the each two-bits indication field indicates whether the one TCI codepoint is associated with an UL TCI state identified by an UL TCI state ID field.

FIG. 8 is a schematic flow chart diagram illustrating a further embodiment of a method 800 according to the present application. In some embodiments, the method 800 is performed by an apparatus, such as a remote unit. In certain embodiments, the method 800 may be performed by a processor executing program code, for example, a microcontroller, a microprocessor, a CPU, a GPU, an auxiliary processing unit, a FPGA, or the like.

The method 800 may include 802 transmitting an MAC CE updating the mapping of multiple TCI codepoints and associated TCI state(s), wherein, each TCI codepoint is associated with one UL TCI state or one DL TCI state or both one DL TCI state and one UL TCI state.

In one embodiment, the MAC CE includes multiple TCI state ID fields each of which is associated with a one-bit indication field, the one-bit indication field indicates whether the associated TCI state ID field identifies an UL TCI state or a DL TCI state. In another embodiment, one of the multiple TCI codepoints is associated with one DL TCI state or both one DL TCI state and one UL TCI state, and accordingly, the MAC CE includes multiple DL TCI state ID fields each of which is associated with one TCI codepoint and is associated with a one-bit indication field, the one-bit indication field indicates whether the one TCI codepoint is further associated with an UL TCI state identified by an UL TCI state ID field. In still another embodiment, the MAC CE includes multiple two-bits indication fields each of which is associated with one TCI codepoint, one bit of each two-bits indication field indicates whether the one TCI codepoint is associated with a DL TCI state identified by a DL TCI state ID field, and the other bit of the each two-bits indication field indicates whether the one TCI codepoint is associated with an UL TCI state identified by an UL TCI state ID field.

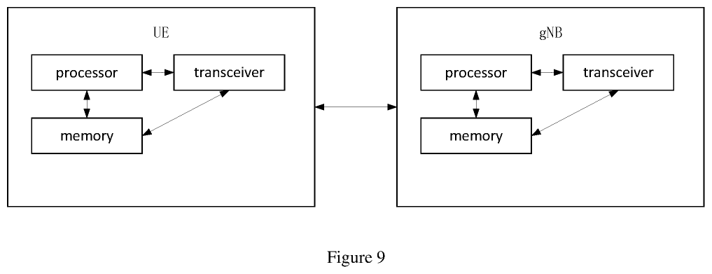

FIG. 9 is a schematic block diagram illustrating apparatuses according to one embodiment.

Referring to FIG. 9, the UE (i.e. the remote unit) includes a processor, a memory, and a transceiver. The processor implements a function, a process, and/or a method which are proposed in FIG. 7.

The UE comprises a receiver that receives an MAC CE updating the mapping of multiple TCI codepoints and associated TCI state(s), wherein, each TCI codepoint is associated with one UL TCI state or one DL TCI state or both one DL TCI state and one UL TCI state.

In one embodiment, the MAC CE includes multiple TCI state ID fields each of which is associated with a one-bit indication field, the one-bit indication field indicates whether the associated TCI state ID field identifies an UL TCI state or a DL TCI state. In another embodiment, one of the multiple TCI codepoints is associated with one DL TCI state or both one DL TCI state and one UL TCI state, and accordingly, the MAC CE includes multiple DL TCI state ID fields each of which is associated with one TCI codepoint and is associated with a one-bit indication field, the one-bit indication field indicates whether the one TCI codepoint is further associated with an UL TCI state identified by an UL TCI state ID field. In still another embodiment, the MAC CE includes multiple two-bits indication fields each of which is associated with one TCI codepoint, one bit of each two-bits indication field indicates whether the one TCI codepoint is associated with a DL TCI state identified by a DL TCI state ID field, and the other bit of the each two-bits indication field indicates whether the one TCI codepoint is associated with an UL TCI state identified by an UL TCI state ID field.

Referring to FIG. 9, the gNB (i.e. base unit) includes a processor, a memory, and a transceiver. The processors implement a function, a process, and/or a method which are proposed in FIG. 8.

The base unit comprises a transmitter that transmits an MAC CE updating the mapping of multiple TCI codepoints and associated TCI state(s), wherein, each TCI codepoint is associated with one UL TCI state or one DL TCI state or both one DL TCI state and one UL TCI state.

In one embodiment, the MAC CE includes multiple TCI state ID fields each of which is associated with a one-bit indication field, the one-bit indication field indicates whether the associated TCI state ID field identifies an UL TCI state or a DL TCI state. In another embodiment, one of the multiple TCI codepoints is associated with one DL TCI state or both one DL TCI state and one UL TCI state, and accordingly, the MAC CE includes multiple DL TCI state ID fields each of which is associated with one TCI codepoint and is associated with a one-bit indication field, the one-bit indication field indicates whether the one TCI codepoint is further associated with an UL TCI state identified by an UL TCI state ID field. In still another embodiment, the MAC CE includes multiple two-bits indication fields each of which is associated with one TCI codepoint, one bit of each two-bits indication field indicates whether the one TCI codepoint is associated with a DL TCI state identified by a DL TCI state ID field, and the other bit of the each two-bits indication field indicates whether the one TCI codepoint is associated with an UL TCI state identified by an UL TCI state ID field.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

What is claimed is:

1. A user equipment (UE) for wireless communication, comprising:
at least one memory; and
at least one processor coupled with the at least one memory and configured to cause the UE to:
receive a medium access control (MAC) control element (CE) updating a mapping of multiple transmission configuration indication (TCI) codepoints and one or more associated TCI states, each TCI codepoint associated with one uplink (UL) TCI state or one downlink (DL) TCI state or both one DL TCI state and one UL TCI state.

2. The UE of claim 1, wherein the MAC CE includes multiple TCI state identity (ID) fields each of which is associated with a one-bit indication field, the one-bit indication field indicating whether the associated TCI state ID field identifies an UL TCI state or a DL TCI state.

3. The UE of claim 1, wherein one of the multiple TCI codepoints is associated with one DL TCI state or both one DL TCI state and one UL TCI state.

4. The UE of claim 3, wherein the MAC CE includes multiple DL TCI state identity (ID) fields each of which is associated with one TCI codepoint and is associated with a one-bit indication field, the one-bit indication field indicating whether the one TCI codepoint is further associated with an UL TCI state identified by an UL TCI state ID field.

5. The UE of claim 1, wherein the MAC CE includes multiple two-bits indication fields each of which is associated with one TCI codepoint, one bit of each two-bits indication field indicating whether the one TCI codepoint is associated with a DL TCI state identified by a DL TCI state ID field, and an other bit of the each two-bits indication field indicating whether the one TCI codepoint is associated with an UL TCI state identified by an UL TCI state ID field.

6. (canceled)

7. A base station for wireless communication, comprising:
at least one memory; and
at least one processor coupled with the at least one memory and configured to cause the base station to:
transmit a medium access control (MAC) control element (CE) updating a mapping of multiple transmission configuration indication (TCI) codepoints and one or more associated TCI states, each TCI codepoint associated with one uplink (UL) TCI state or one downlink (DL) TCI state or both one DL TCI state and one UL TCI state.

8. The base station of claim 7, wherein the MAC CE includes multiple TCI state identity (ID) fields each of which is associated with a one-bit indication field, the one-bit indication field indicating whether the associated TCI state ID field identifies an UL TCI state or a DL TCI state.

9. The base station of claim 7, wherein one of the multiple TCI codepoints is associated with one DL TCI state or both one DL TCI state and one UL TCI state.

10. The base station of claim 9, wherein, the MAC CE includes multiple DL TCI state identity (ID) fields each of which is associated with one TCI codepoint and is associated with a one-bit indication field, the one-bit indication field indicating whether the one TCI codepoint is further associated with an UL TCI state identified by an UL TCI state ID field.

11. The base station of claim 7, wherein the MAC CE includes multiple two-bits indication fields each of which is associated with one TCI codepoint, one bit of each two-bits indication field indicating whether the one TCI codepoint is associated with a DL TCI state identified by a DL TCI state ID field, and an other bit of the each two-bits indication field indicating whether the one TCI codepoint is associated with an UL TCI state identified by an UL TCI state ID field.

12. (canceled)

13. A processor for wireless communication, comprising:
at least one controller coupled with at least one memory and configured to cause the processor to:
receive a medium access control (MAC) control element (CE) updating a mapping of multiple transmission configuration indication (TCI) codepoints and one or more associated TCI states, each TCI codepoint associated with one uplink (UL) TCI state or one downlink (DL) TCI state or both one DL TCI state and one UL TCI state.

14. The processor of claim 13, wherein the MAC CE includes multiple TCI state identity (ID) fields each of which is associated with a one-bit indication field, the one-bit indication field indicating whether the associated TCI state ID field identifies an UL TCI state or a DL TCI state.

15. The processor of claim 13, wherein one of the multiple TCI codepoints is associated with one DL TCI state or both one DL TCI state and one UL TCI state.

16. The processor of claim 15, wherein the MAC CE includes multiple DL TCI state identity (ID) fields each of which is associated with one TCI codepoint and is associated with a one-bit indication field, the one-bit indication field indicating whether the one TCI codepoint is further associated with an UL TCI state identified by an UL TCI state ID field.

17. The processor of claim 16, wherein the MAC CE includes multiple two-bits indication fields each of which is associated with one TCI codepoint, one bit of each two-bits indication field indicating whether the one TCI codepoint is associated with a DL TCI state identified by a DL TCI state ID field, and an other bit of the each two-bits indication field indicating whether the one TCI codepoint is associated with an UL TCI state identified by an UL TCI state ID field.

18. A method performed by a user equipment (UE), the method comprising:
receiving a medium access control (MAC) control element (CE) updating a mapping of multiple transmission configuration indication (TCI) codepoints and one or more associated TCI states, each TCI codepoint associated with one uplink (UL) TCI state or one downlink (DL) TCI state or both one DL TCI state and one UL TCI state.

19. The method of claim 18, wherein the MAC CE includes multiple TCI state identity (ID) fields each of which is associated with a one-bit indication field, the one-bit indication field indicating whether the associated TCI state ID field identifies an UL TCI state or a DL TCI state.

20. The method of claim 18, wherein one of the multiple TCI codepoints is associated with one DL TCI state or both one DL TCI state and one UL TCI state.

21. The method of claim 20, wherein the MAC CE includes multiple DL TCI state identity (ID) fields each of which is associated with one TCI codepoint and is associated with a one-bit indication field, the one-bit indication field indicating whether the one TCI codepoint is further associated with an UL TCI state identified by an UL TCI state ID field.

22. The method of claim 18, wherein the MAC CE includes multiple two-bits indication fields each of which is associated with one TCI codepoint, one bit of each two-bits indication field indicating whether the one TCI codepoint is associated with a DL TCI state identified by a DL TCI state ID field, and an other bit of the each two-bits indication field indicating whether the one TCI codepoint is associated with an UL TCI state identified by an UL TCI state ID field.
